(19) United States
(12) Patent Application Publication
(10) Pub. No.: US 2018/0130080 A1
(43) Pub. Date: May 10, 2018

(54) Method for Increasing Discount by Winners Numbers

(71) Applicant: Ithzak Belo, Tel Aviv (IL)

(72) Inventor: Ithzak Belo, Tel Aviv (IL)

(21) Appl. No.: 15/345,848

(22) Filed: Nov. 8, 2016

(51) Int. Cl. G06Q 30/02

(52) U.S. Cl. CPC G06Q 30/0212

(57) ABSTRACT

The possibility to give to specific customer, greater discount, using the method of counting customers who bought after he bought, and given a number line as a buyer, and give him a discount, which is a big X TIMES FROM THE REGULAR DISCOUNT, IF NUMBERS OF ALL BUYERS WILL BE X TIMES BIGGER THAN HIS NUMBER LINE AS BUYER

### TECHNICAL FIELD

The purpose of this invention is to create a marketing tool to give customers great discount or benefits, without increasing the marketing cost, of business owner.

### Background Art

Brief description of knowledge in the field, prior to this invention

The methods used prior to this invention are:

1. 1+1 system which provides a cheaper price, per unit, those who buy 2 units
2. Card system, this method, the customer shopping at certain times, documented in writing, and the business owner, gives the customer a discount after several shopping.
3. The method of shopping group, including all customer gets a discount if you join group shopping, and if the amount of recruits, reaches a certain amount of buyers the method: The amount of the first buyers, giving a discount, a certain amount of buyers within a certain time.
5. The method: Customer Number: X, this method gives a discount to the customer, which is a customer number: X
6. Method: Lottery discount to customers, where a customer gets a discount, if the number received, will be released lottery number

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts schematically the method of the invention for purchasing.

FIG. 2 depicts schematically the method of the invention for gambling.

### THE INVENTION

We will start with a brief summary of the invention. This invention, give the business owner the opportunity to give a bigger discount, without increasing cost The method to give a bigger discount, of this invention is: a business owner creates Deal, within a site or application or hardware. The number of buyers in the deal is counted and exhibit to the customers. The deal promises, bigger discount if the number of buyers, will be x times bigger than the customer number, that he get when he joined the deal as a buyer x can be between 1 to 1000000 when x is lower the deal is more effective.

This invention allows the business owner to give a bigger discount, without conditioning it, a large number of buyers, or luck, or by obtaining a special line number as a buyer, like buyer number 10000.

For example: Buy products, cost $50. Get back $50, if the number of buyers in the deal will be 5 times larger than the number of your turn as a buyer this deal will not increase the cost of marketing, if the business owner, is ready to give 10 dollar discount, to all the customers, who bought products that cost 50 dollars, that's because he give back 50 dollars, only if he sale, product that cost to the general customers in a certain time 250 dollars (5×50) so its like he gave back 10 dollars, to every customer from the five customers who bought products that cost to them 50 dollars

Now with more detailed description of the invention—winners' numbers method for increasing discount—the purpose of this invention is to create a marketing tool to give customers\gamblers\contributors great discount or great benefits, or great financial profit, or great lottery winning without increasing the marketing cost, of business owner\entrepreneur

The method to give bigger discount, of this invention is: a business owner creates Deal, within a site or application or hardware

The number of buyers in the deal are counted and exhibit to the customers, every customer who bought get line number as buyer. The deal promises, bigger discount if the number of buyers, will be x times bigger than the customer number, that he get when he bought\ joined the deal as buyer in the deal x can be between 1 to 100000000000 when x is lower the deal is more effective, this deals can be limited in time, or unlimited in time.

when this deals are limited in time only some buyers will get the greater discount or benefits, or financial profit, or lottery winning when this deal are not limited in time all the buyers have good chance to get the greater discount or benefits, or financial profit, or lottery winning

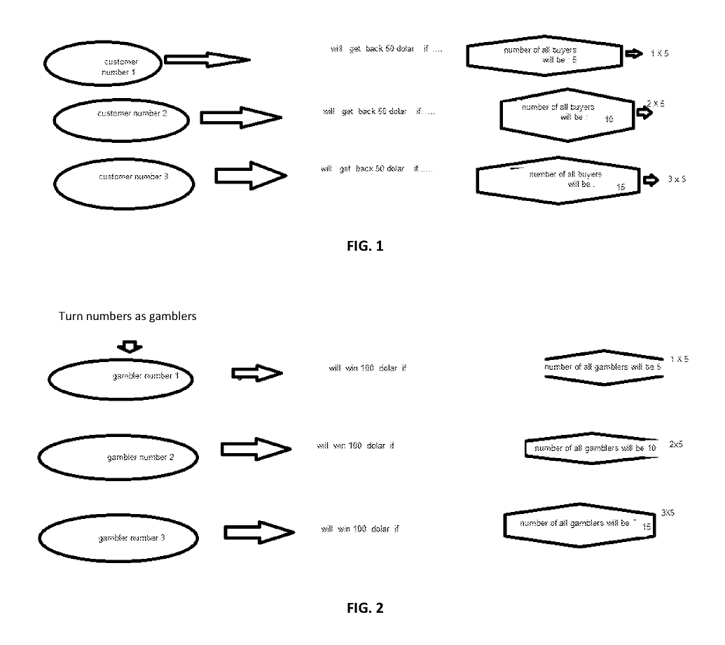

Brief description of the several views of the drawing FIG. 1 for example: Buy products, cost $50. Get back $50, if the number of buyers in the deal will be 5 times larger than the number of your turn as a buyer this deal will not increase the cost of marketing, if the business owner, is ready to give 10 dollars discount, to all the customers, who bought products that cost to them 50 dollars, that's because he gives back 50 dollars to only one customer from any group of five customer who bought products that cost to them 50 dollars.

FIG. 2 for example buy a lottery ticket, that cost 50$ and you win 100 $ if the number of gamblers will be 5 times larger than your turn number as gambler, even if your ticket numbers will not be the same as the winning numbers in this lottery. in that deal, the lottery owner gives 100$ only to one gambler from all the certain groups of five gamblers that bet after him, and only if he get 250$ from certain group of gamblers, so he earn 150$ from every group of five gamblers. Gambler number 1 will win 100 $ when will be 5 gamblers. Gambler number 2 will win 100$ when will be 10 gamblers (2×5). gambler number 3 will win 100$ when will be 15 gamblers in this deal (3×5) and so on . . . .

What is claimed is:

1: business deals, that, are published on websites\application\hardware, count the number of buyers and exhibitors the number of buyers in real time on the website and guaranteeing to the customers a discount\benefit\\profit, conditioned to that the number of buyers, will be x times bigger, from the turn of the customer number, as a buyer

2: Contribution deals, that, are published on websites\application\hardware, count the number of Contributors [symbol] and exhibitors the number of them in real time on the website and guaranteeing to the Contributors a discount\benefit\\profit, conditioned to that the number of Contributors, will be x times bigger, from the turn of the Contributors number, as a Contributors.

3: bet\lottery deals, that, are published on websites\application\hardware, count the number of Gamblers and exhibitors the number of them in real time on the website and guaranteeing to the Gamblers a discount\benefit\\profit, conditioned to that the number of, Gamblers will be x times bigger, from the turn of the Gamblers number, as a Gamblers
